(19) United States
(12) Patent Application Publication
(10) Pub. No.: US 2018/0189173 A1
(43) Pub. Date: Jul. 5, 2018

(54) SYSTEM MEMORY MIGRATION

(71) Applicant: HEWLETT-PACKARD DEVELOPMENT COMPANY, LP., HOUSTON, TX (US)

(72) Inventors: CARLOS HAAS COSTA, PALO ALTO, CA (US); CHRISTIAN PERONE, PORTO ALEGRE (BR); DIEGO RAHN MEDAGLIA, PORTO ALEGRE (BR)

(21) Appl. No.: 15/747,213

(22) PCT Filed: Sep. 18, 2015
(86) PCT No.: PCT/US2015/050987

§ 371 Date: Jan. 24, 2018

(51) Int. Cl. G06F 12/02; G06F 12/1027; G06F 13/16

(52) U.S. Cl. CPC G06F 12/0246; G06F 13/1694; G06F 12/1027

(57) ABSTRACT

Examples include a system comprising a non-volatile memory and a volatile memory. Examples resume the system to a prior state using state information stored in the non-volatile memory. After resuming the system, examples migrate a system memory that is stored in the non-volatile memory to the volatile memory.

### BACKGROUND

For systems, such as personal computers, portable computing devices, servers, etc., various types of memory may be implemented for different purposes. Volatile memory may refer to a device/module that loses stored information upon removal of power from the device/module. Non-volatile memory may refer to a device/module that may store information even if power is removed from the device/module.

### DRAWINGS

FIG. 1A is a block diagram of an example system that may make use of the disclosure.

FIG. 1B is a block diagram of an example system that may make use of the disclosure.

FIG. 2 is a block diagram of an example system that may make use of the disclosure.

FIG. 3 is a block diagram of some components of an example system.

FIG. 4 is a block diagram of some components of an example system.

FIG. 5 is a flowchart that illustrates an example sequence of operations that may be performed by an example system to migrate a system memory.

FIG. 6 is a flowchart that illustrates an example sequence of operations that may be performed by an example system to migrate a system memory.

FIG. 7 is a flowchart that illustrates an example sequence of operations that may be performed by an example system to migrate a system memory.

FIG. 8 is a flowchart that illustrates an example sequence of operations that may be performed by an example system to transition to a lower-power mode.

FIG. 9 is a flowchart that illustrates an example sequence of operations that may be performed by an example system to migrate a system memory.

Throughout the drawings, identical reference numbers designate similar, but not necessarily identical, elements. Moreover the drawings provide examples and/or implementations consistent with the description; however, the description is not limited to the examples and/or implementations provided in the drawings.

### DESCRIPTION

Example computing systems may comprise at least one processing resource, a volatile memory, and a non-volatile memory. A computing system, as used herein, may include, for example, a personal computer, a portable computing device (e.g., laptop, tablet computer, smartphone), a server, blades of a server, a processing node of a server, a system-on-a-chip (SOC) computing device, a processing node of a SOC device, and/or other such computing devices/systems. As used herein, a computing system may be referred to as simply a system.

Examples of volatile memory may comprise various types of random access memory (RAM) (e.g., SRAM, DRAM, DDR SDRAM, T-RAM, Z-RAM), as well as other memory devices/modules that lose stored information when powered off. Examples of non-volatile memory (NVM) may comprise read-only memory (ROM) (e.g., Mask ROM, PROM, EPROM, EEPROM, etc.), flash memory, solid-state memory, non-volatile state RAM (nvSRAM), battery-backed static RAM, ferroelectric RAM (FRAM), magnetoresistive RAM (MRAM), phase-change memory (PCM), magnetic tape, optical drive, hard disk drive, 3D cross-point memory (3D XPoint), programmable metallization cell (PCM) memory, silicon-oxide-nitride-oxide-silicon (SONOS) memory, resistive RAM (RRAM), domain-wall memory (DWM), nano-RAM, floating junction gate RAM (FJG RAM), memristor memory, spin-transfer torque RAM (STT-RAM), as well as other memory devices/modules that maintains stored information across power cycles (e.g., off/on). Non-volatile memory that stores data across a power cycle may also be referred to as a persistent data memory. As used herein, memory may comprise one device and/or module or a combination devices and/or modules.

Furthermore, example systems may comprise a system memory, where the system memory refers to a portion of memory dedicated to storing current applications/programs/processes and data that are in use by the system. As will be appreciated, the system memory may store instructions for execution by a processing resource and data upon which the processing resource will operate when executing such instructions.

In some example systems, a volatile memory may have lower read/write times when compared to non-volatile memory—i.e., volatile memory may have faster read/write speeds compared to non-volatile memory. As will be appreciated, faster read/write speeds for a memory may correspond to increases in processing resource efficiency. Therefore, for optimal processing resource efficiency for a system, the system memory may be stored in a volatile memory. However, as discussed, data stored in volatile memory is not retained across a power cycle (i.e., when power is removed from the system then returned to the system). For example, if the system is powered down, transitions to hibernation, etc., which may be referred to as transitioning to a lower-power mode, data stored in the volatile memory is not retained. Hence, if the system memory is stored in the volatile memory, the system memory may not be retained upon transition to a lower power mode. Because the system memory is not retained across a power cycle, booting or resuming the system from a lower-power mode may necessitate loading data and instructions into the volatile memory, which may result in slower boot/resume times.

In contrast, if the system memory is stored in a non-volatile memory, the system memory may be retained across a power cycle. As will be appreciated, boot and/or resume times for a system storing system memory in a non-volatile memory may be less relative to boot/resume times associated with a system in which the system memory is loaded into the volatile memory during resume of the system. Accordingly, examples provided herein may resume a system from system memory stored in a non-volatile memory. After resuming the system with the system memory stored in the non-volatile memory, the system may migrate the system memory to the volatile memory. As will be appreciated, migrating the system memory after resuming the system may facilitate usage of the higher processing resource efficient volatile memory.

In addition, in some examples, before transitioning to a lower-power mode, example systems may copy the system memory of the volatile memory to the non-volatile memory. In these examples, the system may analyze executing applications of the system to generate state information associated with a state of the system prior to transitioning to a lower-power mode, which may be referred to as a prior state. The state information may be stored in the non-volatile memory with the system memory. In such examples, when the system is resumed, the system may resume the system to the prior state using the state information stored in the non-volatile memory. Therefore, as will be appreciated, examples may resume a system by using system memory stored in a non-volatile memory. As will be appreciated, the time needed to resume the system may be lower as compared to a time associated with resuming the system if the system memory used is loaded into the volatile memory.

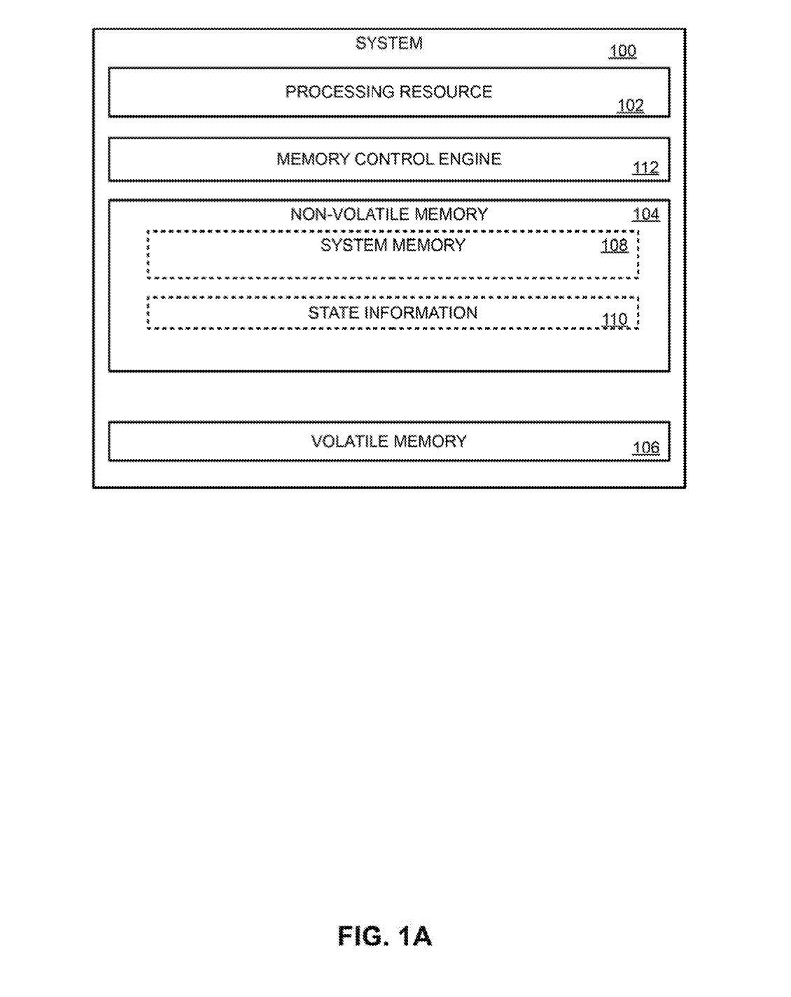

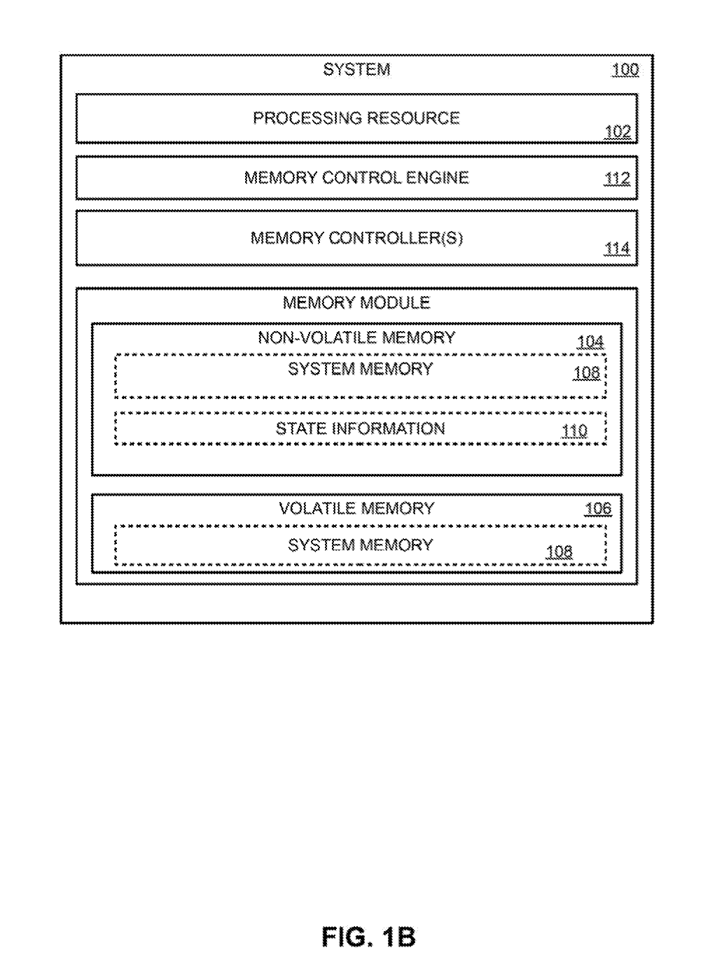

Turning now to the figures, and particularly to FIGS. 1A-B, these figures provide block diagrams that illustrate examples of a system 100. Examples of a system as disclosed herein include a personal computer, a portable electronic device (e.g., a smart phone, a tablet, a laptop, a wearable device, etc.), a workstation, a smart device, server, a processing node of a server, a data center comprising a plurality of servers, and/or any other such data processing devices. In the examples of FIGS. 1A and B, the system 100 comprises a processing resource 102, a non-volatile memory 104, and a volatile memory 106.

In the examples described herein, a processing resource 102 may include at least one hardware-based processor. Furthermore, the processing resource 102 may include one processor or multiple processors, where the processors may be configured in a single system 100 or distributed across multiple systems connected locally and/or remotely. As will be appreciated, a processing resource 102 may comprise one or more general purpose data processors and/or one or more specialized data processors. For example, the processing resource 102 may comprise a central processing unit (CPU), a graphics processing unit (GPU), an application-specific integrated circuit (ASIC), and/or other such configurations of logical components for data processing. In some examples, the processing resource 102 comprises a plurality of computing cores that may process/execute instructions in parallel, synchronously, concurrently, in an interleaved manner, and/or in other such instruction execution arrangements.

In examples, the volatile memory, as used herein may comprise memory modules/devices that include random access memory (RAM) as well as other memory modules/devices, such as cache memory of processing resources, etc. The non-volatile memory may comprise modules/devices that persist data across a power cycle. In some examples, the non-volatile memory correspond to a class of non-volatile memory which is referred to as storage class memory (SCM). In these examples, the SCM non-volatile memory is byte-addressable, synchronous with a processing resource, and in a processing resource coherent domain. Moreover, SCM non-volatile memory may comprise types of memory having relatively higher read/write speeds as compared to other types of non-volatile memory, such as hard-drives or magnetic tape memory devices. Examples of SCM non-volatile memory include some types of flash memory, RRAM, memristors, PCM, MRAM, STT-RAM, as well as other types of higher read/write speed persistent data memory devices. As will be appreciated, due to relatively low read and write speeds of some types of non-volatile memory, such as spin-disk hard drives, NAND flash, magnetic tape drives, processing resources may not directly process instructions and data with these types of non-volatile memory. However, a processing resource may process instructions and data directly with a SCM non-volatile memory.

In FIGS. 1A-B, the non-volatile memory 104 includes a system memory 108 stored therein. Furthermore the non-volatile memory 104 includes state information 110 associated with a prior state of the system 100. In some examples, some state information 110 may be stored in the system memory 108, where such state information stored in the system memory 108 may correspond to instances of an operating system (OS), applications, and/or processes executing on the system 100. State information 110 not stored in the system memory 108 may correspond to early boot stages of the system 100, such as BIOS code, firmware code, etc. In addition, the system 100 comprises a memory control engine 112, where the memory control engine 112 may migrate the system memory 108 to the volatile memory 106 after the system is resumed using the state information stored in the non-volatile memory 104. FIG. 1B illustrates an example where the system memory 108 stored in the non-volatile memory 104 has been migrated to the volatile memory. Migration of the system memory 108 may comprise copying the data of the system memory of the non-volatile memory to the volatile memory 106. As will be appreciated, such migration may be done in sections and the migration may be a background and/or low-priority process that is performed following resume of the system 100. In FIG. 1B, the system 100 further includes at least one memory controller 114. Furthermore, a memory controller 114 corresponds to hardware components that control the reading and writing of data to memory (such as the non-volatile memory 104 and/or the volatile memory 106).

While not shown in FIGS. 1A-B, for interface with a user or operator, some example systems may include a user interface incorporating one or more user input/output devices, e.g., one or more buttons, a display, a touchscreen, a speaker, etc. The user interface may therefore communicate data to the processing resource and receive data from the processing resource. For example, a user may input one or more selections via the user interface, and the processing resource may cause data to be output on a screen or other output device of the user interface. Furthermore, the system may comprise a network interface device. As will be appreciated, the network interface device comprises one or more hardware devices to communicate data over one or more communication networks, such as a network interface card.

Furthermore, example systems, such as the example system of FIGS. 1A-B, may comprise engines, where such engines (such as the memory control engine 112) may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to process and execute those instructions.

In some examples, a system implementing such engines may include the machine-readable storage medium storing the instructions and the processing resource to process the instructions, or the machine-readable storage medium may be separately stored and accessible by the system and the processing resource. In some examples, engines may be implemented in circuitry. Moreover, processing resources used to implement engines may comprise at least one central processing unit (CPU), a graphics processing unit (GPU), an application specific integrated circuit (ASIC), a specialized controller (e.g., a memory controller) and/or other such types of logical components that may be implemented for data processing.

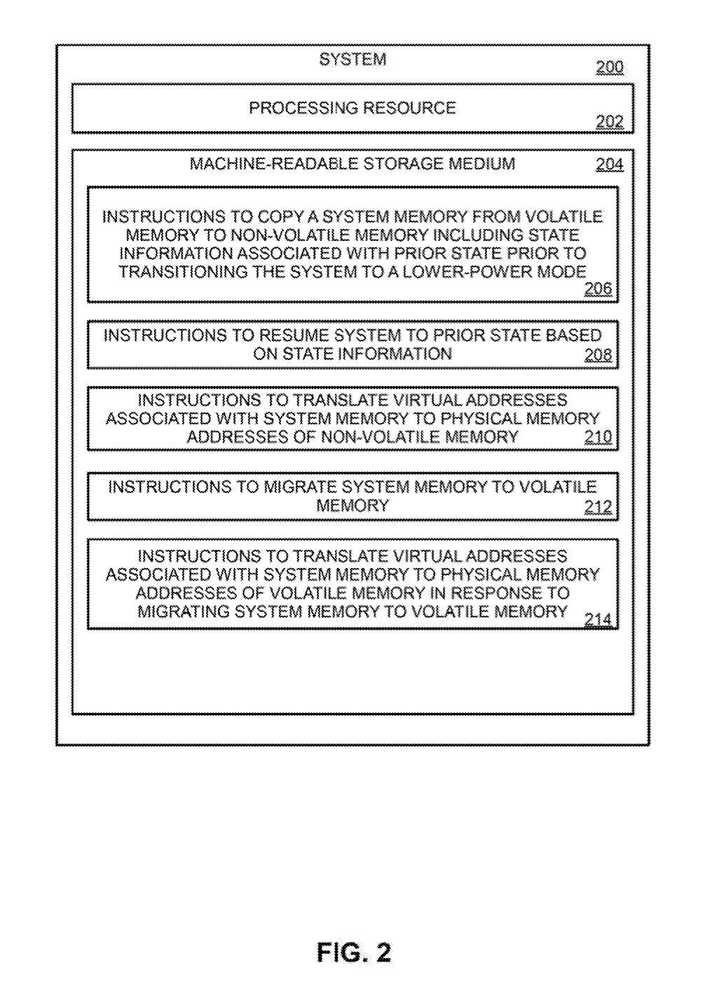

FIG. 2 provides a block diagram that illustrates an example system 200. In this example, the system 200 comprises at least one processing resource 202 and a machine readable storage medium 204. The machine-readable storage medium 204 may represent the random access memory (RAM) devices comprising the main storage of the example system 100, as well as any supplemental levels of memory, e.g., cache memories, non-volatile or backup memories (e.g., programmable or flash memories), read-only memories, etc. In addition, machine-readable storage medium 204 may be considered to include memory storage physically located elsewhere, e.g., any cache memory in a microprocessor, as well as any storage capacity used as a virtual memory, e.g., as stored on a mass storage device or on another system in communication with the example system 200. Furthermore, the machine-readable storage medium 204 may be non-transitory. In some examples, the processing resource 202 and machine-readable storage medium 204 may correspond to processing units and memory devices arranged in at least one server. In other examples, the processing resource 202 and machine-readable storage medium may be arranged in a system-on-a-chip device.

In addition, the machine-readable storage medium 204 may be encoded with and/or store instructions that may be executable by the processing resource 202, where execution of such instructions may cause the processing resource 202 and/or system 200 to perform the functionalities, processes, and/or sequences of operations described herein. In the example of FIG. 2, the machine-readable storage medium 204 comprises instructions to copy a system memory from a volatile memory to a non-volatile memory including state information associated with a prior state of the system 200 prior to transitioning the system 200 to a lower-power mode 206. In addition, the machine-readable storage medium 204 comprises instructions to resume the system 200 to the prior state based on the state information stored in the non-volatile memory 208. Furthermore, the machine-readable storage medium 204 comprises instructions to translate virtual addresses associated with the system memory to physical memory addresses of the non-volatile memory 210. The machine-readable storage medium 204 also comprises instructions to migrate the system memory to the volatile memory 212. In addition, the machine-readable storage medium 204 comprises instructions to translate virtual addresses associated with the system memory to physical memory addresses of the volatile memory in response to migrating the system memory to the volatile memory 214.

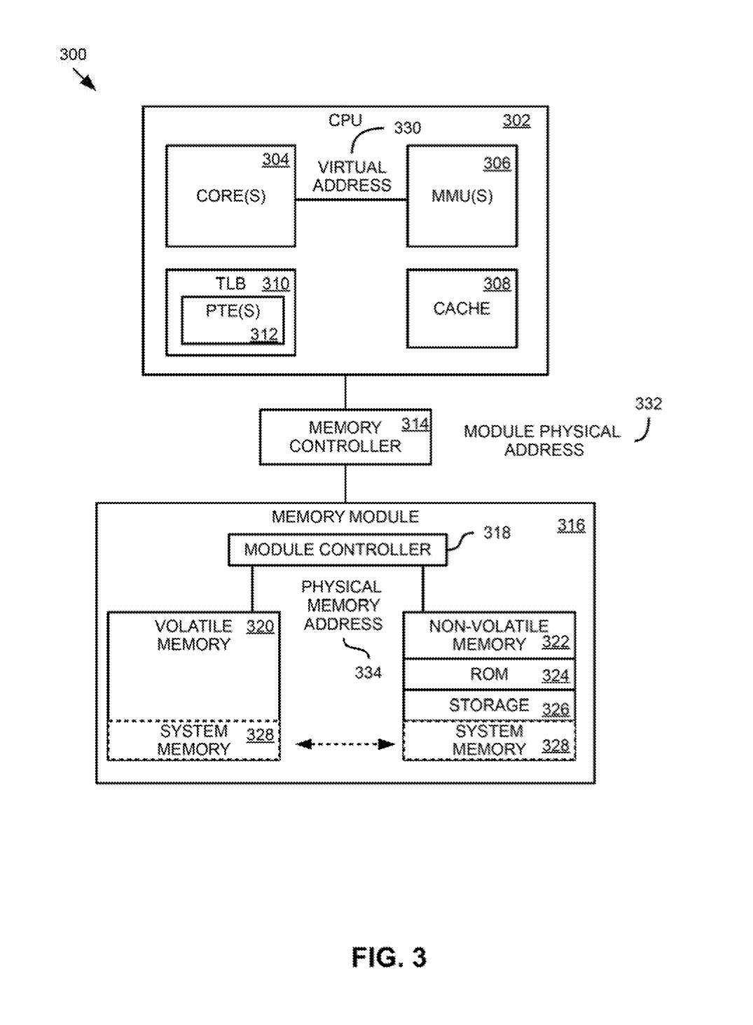

FIG. 3 provides a block diagram that illustrates some components of an example system 300. As discussed, in some examples, a processing resource comprises a central processing unit (CPU), and in this example, the system 300 comprises a CPU 302 that includes at least one core 304. In some examples, the CPU 302 may comprise one core 304, and in other examples the CPU 302 may comprise two cores 304 (referred to as a dual-core configuration), four cores (referred to as a quad-core configuration), etc. As shown, the CPU 302 further comprises at least one memory management unit (MMU) 306. In some examples, the CPU 302 comprises at least one MMU 306 for each core 304. In addition, in this example, the CPU comprises cache memory 308, where the cache memory 308 may comprise one or more cache memory levels that may be used for storing decoded instructions, fetched data, and results. Furthermore, the CPU 302 comprises at least one translation look-aside buffer (TLB) 310 that includes page table entries (PTEs) 312.

A translation look-aside buffer may correspond to a cache specially purposed for facilitating virtual address translation. In particular the TLB stores page table entries that map virtual addresses to an intermediate addresses and/or physical memory addresses. A memory management unit may search a TLB with a virtual address to determine a corresponding intermediate address and/or physical memory address. A TLB is limited in size, such that not all necessary PTEs may be stored in the TLB. Therefore, in some examples additional PTEs may be stored in other areas of memory, such as a volatile memory and/or a non-volatile memory. As will be appreciated, the TLB represents a very high speed memory location, such that address translations performed based on data stored in a TLB will be faster than translations performed with PTEs located elsewhere.

In this example, the CPU 302 is connected to a memory controller 314, and in turn, the memory controller 314 is connected to a memory module 316. The memory module 316 comprises a module controller 318, volatile memory 320, and non-volatile memory 322. As shown, the non-volatile memory 322 may comprise a portion associated with read-only memory (ROM) 324 and a portion associated with storage 326. As discussed previously, a system memory 328 may be stored in the volatile memory 320 and/or the non-volatile memory 322. For example, prior to transitioning to a lower-power mode (e.g. a complete power off, a system suspend, a system hibernation, a power-down of some components, etc.), the system 300 may copy the system memory 328 from the volatile memory 320 to the non-volatile memory 322. As another example, during a resume of the system (e.g., a system power-up, resuming from system hibernation, resuming from a system suspend, returning power to some powered-down components, etc.), the system 300 may utilize the system memory 328 stored in the non-volatile memory 322, and the system 300 may migrate the system memory 328 stored in the non-volatile memory 322 to the volatile memory 320.

As will be appreciated, the cores 304 of the CPU 302 perform operations to implement an instruction cycle, which may also be referred to as the fetch-decode-execute cycle. As used herein, processing instructions may refer to performing the fetching, decoding, and execution of instructions. During the instruction cycle, the CPU 302 decodes instructions to be executed, where the decoded instructions include memory addresses for data upon which operations of the instruction are to be performed (referred to as source operands) as well as memory addresses where results of performing such operations are to be stored (referred to as target operands). As will be appreciated, the memory addresses of decoded instructions are virtual addresses. Moreover, a virtual address may refer to a location of a virtual address space that may be assigned to a process/application. A virtual address is not directly connected to a particular memory location of a memory device (such as the volatile memory 320 or non-volatile memory 322). Consequently, when preparing to execute an instruction, a core 304 may communicate a virtual address to an associated MMU 306 for translation to a physical memory address such that data stored at the physical memory address may be fetched for execution. A physical memory address may be directly related to a particular physical memory location (such as a particular location of the volatile memory 320 and/or non-volatile memory 322). Therefore, as shown in FIG. 3, at the core 304 level, memory addresses correspond virtual addresses 330.

The MMU 306 translates a virtual address to a physical memory address based on a mapping of virtual addresses to physical memory addresses that may be stored in one or more page table entries 312. As will be appreciated, in this example, the CPU 302 includes a TLB 310 that stores page table entries 312 with which the MMU 306 may translate a virtual address. In the example implementation illustrated in FIG. 3, the memory module 216 comprises both volatile memory 320 and the non-volatile memory 322. Therefore, in examples such as the example of FIG. 3, the virtual address is first translated to a module physical address 332. In other words, the system 300 does not directly translate the virtual address to the physical memory address, instead, the virtual address is translated to an intermediate address (which in this case is referred to as the module physical address). At the memory module 316, the module controller 318 may translate the module physical address 332 to a physical memory address 334, where the physical memory address 334 may correspond to a particular physical memory location of the volatile memory 320 or the non-volatile memory 322.

In examples similar to the example of FIG. 3, the system 300 may translate a virtual address 330 that is associated with the system memory 328 to a physical memory address 334 of the volatile memory 320 or the non-volatile memory 322. For example, if the system memory 328 is stored in the non-volatile memory 322, such as upon resuming system 300, the system translates a virtual address 330 associated with the system memory 328 to a corresponding physical memory address 334 of the non-volatile memory 322. As another example, if the system memory 328 is stored in the volatile memory 320, such as after migration of the system memory 328 to the volatile memory 320 from the non-volatile memory 322, the system 300 translates a virtual address associated with the system memory 328 to a physical memory address 334 of the volatile memory 320.

Furthermore, in examples similar to the example of FIG. 3, where volatile memory 320 and non-volatile memory 322 may be implemented in a single memory module 316 with a module controller 318, migration of the system memory 328 from the non-volatile memory 322 to the volatile memory 320 may be performed at the memory module 316 level (i.e., without processing migration associated instructions with CPU 302 components). Furthermore, in examples in which the volatile memory 320 and non-volatile memory 322 are implemented in a single memory module 316 and where the read/write of data is may be controlled by the module controller 318, it will be appreciated that a portion of the translation of a virtual address to a physical memory address may be performed by the module controller 318. In such examples, the module controller 318 controls whether a system memory 328 stored in the volatile memory 320 or the non-volatile memory 322 is used during processing of instructions. Furthermore, in some examples, a single memory controller 314 may be connected to the memory module 316 over a single channel. As will be appreciated, because the memory module 316 includes a module controller 318 memory access may be controlled by the module controller 318. In some examples similar to the example of FIG. 3, the memory module 316 may comprise a cache memory that may store page table entries, where the page table entries may map module physical addresses to physical memory addresses. In such examples, the module controller 318 may translate module physical addresses 332 to physical memory addresses 334 based at least in part on such page table entries stored at the memory module 316.

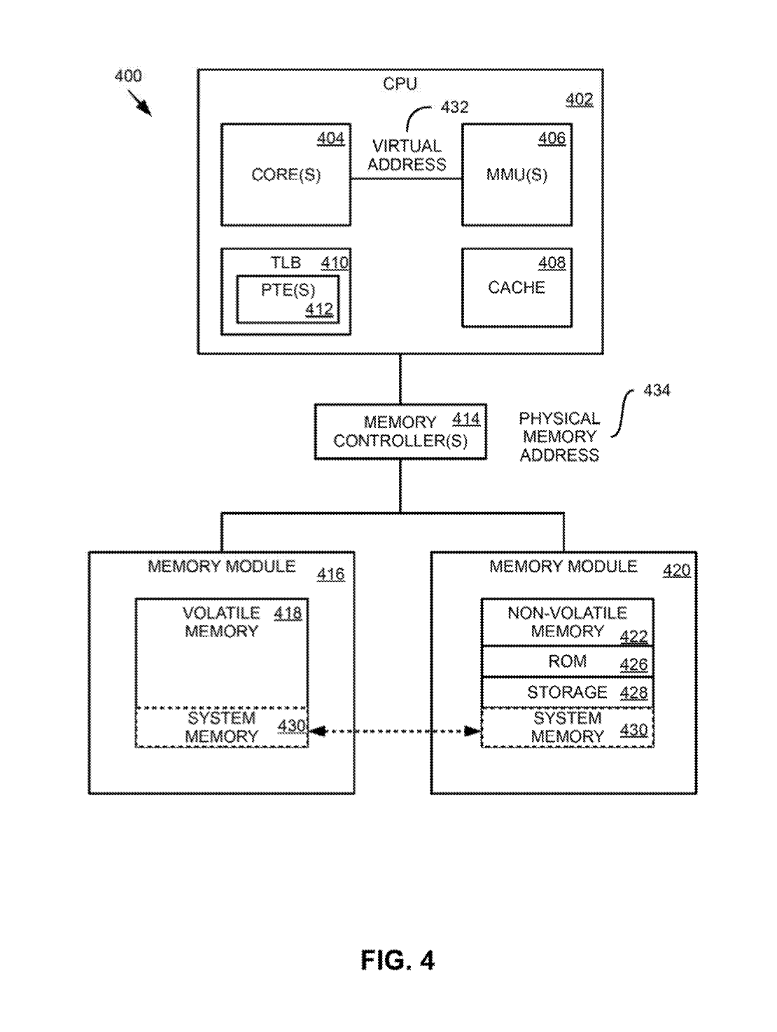

FIG. 4 provides a block diagram that illustrates some components of an example system 400. In this example, the system 400 comprises a CPU 402 that includes at least one core 404, a MMU 406 associated with each core 404. In addition, the CPU 402 comprises a cache memory 408 and a TLB 410, where the TLB 410 comprises PTEs 412 that may map virtual addresses to physical memory addresses. In the example system 400 of FIG. 4, the system 400 further comprises at least one memory controller 414, a first memory module 416 that comprises a volatile memory 418, and a second memory module 420 that comprises non-volatile memory 422. In some examples, the system 400 may comprise a memory controller 414 for each memory module 416, 420. In other examples, the system 400 may comprise a memory controller 414 that is connected to each memory module 416, 420 with a different channel. As shown, the non-volatile memory may also comprise a ROM 424 and storage 426.

In the example, the system 400 further comprises system memory 430 that may be stored in the non-volatile memory 422 and/or the volatile memory 430. In particular, when the system is resumed from a lower-power mode (such as powered-up from a complete power down, resumed from hibernation, resumed from a system suspend, power is returned to some powered down components, etc.), the system memory 430 may be stored in the non-volatile memory 420. Therefore, when the system 400 is resumed, the system 400 may process instructions using the system memory 430 stored in the non-volatile memory 422. After the system 400 is resumed, and while the system 400 is processing instructions using the system memory 430 stored in the non-volatile memory 422, the system may migrate the system memory 430 to the volatile memory 418. After migrating the system memory 430 to the volatile memory 418, the system may process instructions using the system memory 430 stored in the volatile memory 418.

In this example, a respective core 404 communicates virtual addresses 432 to a respective MMU 406 for translation thereby. The respective MMU 406 translates the virtual address to a physical memory address 434. In some examples, a respective virtual address associated with the system memory 430 may be translated to a respective physical memory address of the volatile memory 418 or a respective physical memory address of the non-volatile memory 420. For example, after resuming the system 400 from a lower-power mode, the system 400 may translate a virtual address 432 associated with the system memory 430 to a physical memory address 434 of the non-volatile memory. After migrating the system memory 430 from the non-volatile memory 422 to the volatile memory 418, the system may translate a virtual address 432 associated with the system memory 430 to a physical memory address 434 of the volatile memory 418.

In examples similar to the example system 400 of FIG. 4, migration of the system memory 430 from the non-volatile memory 422 to the volatile memory 418 may be performed by processing instructions associated with the migration thereof. Similarly, copying the system memory 430 from the volatile memory 418 to the non-volatile memory 422 prior to transitioning to a lower-power mode may be performed by processing instructions associated with the copying thereof.

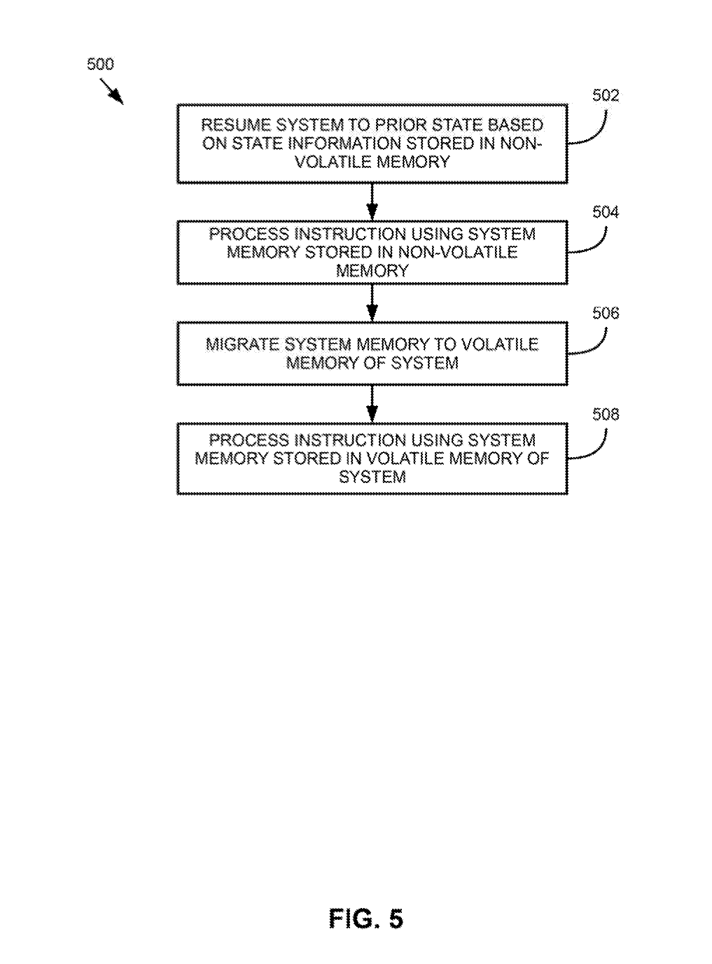

FIGS. 5-9 provide flowcharts that provide example sequences of operations that may be performed by an example system and/or a processing resource thereof to perform example processes and methods. In some examples, the operations included in the flowcharts may be embodied in a memory resource (such as the example machine-readable storage medium 204 of FIG. 2) in the form of instructions that may be executable by a processing resource to cause the system (e.g., the system 100 of FIGS. 1A-B, the system 200 of FIG. 2) to perform the operations corresponding to the instructions. Additionally, the examples provided in FIGS. 5-9 may be embodied in systems, machine-readable storage mediums, processes, and/or methods. In some examples, the example processes and/or methods disclosed in the flowcharts of FIGS. 5-9 may be performed by one or more engines implemented in a system.

Turning now to FIG. 5, this figure provides a flowchart 500 that illustrates an example sequence of operations that may be performed by an example system. As shown, the system may resume to a prior state based on state information stored in a non-volatile memory (NVM) of the system (block 502). As discussed, the prior state of the system corresponds to processes and applications that were executing on the system prior to the system transitioning to a lower-power mode. Upon resume, the system processes instructions of executing applications/processes using a system memory stored in the non-volatile memory (block 504). As will be appreciated, processing instructions using the system memory stored in the non-volatile memory may comprise reading and writing data to the system memory for executing applications/processes. After resuming the system, the system may migrate the system memory stored in the non-volatile memory to a volatile memory (block 506). In some examples, the system migrates the system memory to the volatile memory while processing instructions of applications/processes using the system memory stored in the non-volatile memory. In some examples, migration of the system memory is performed in sections. After migration of the system memory to the volatile memory, the system processes instructions using the system memory stored in the volatile memory of the system (block 508).

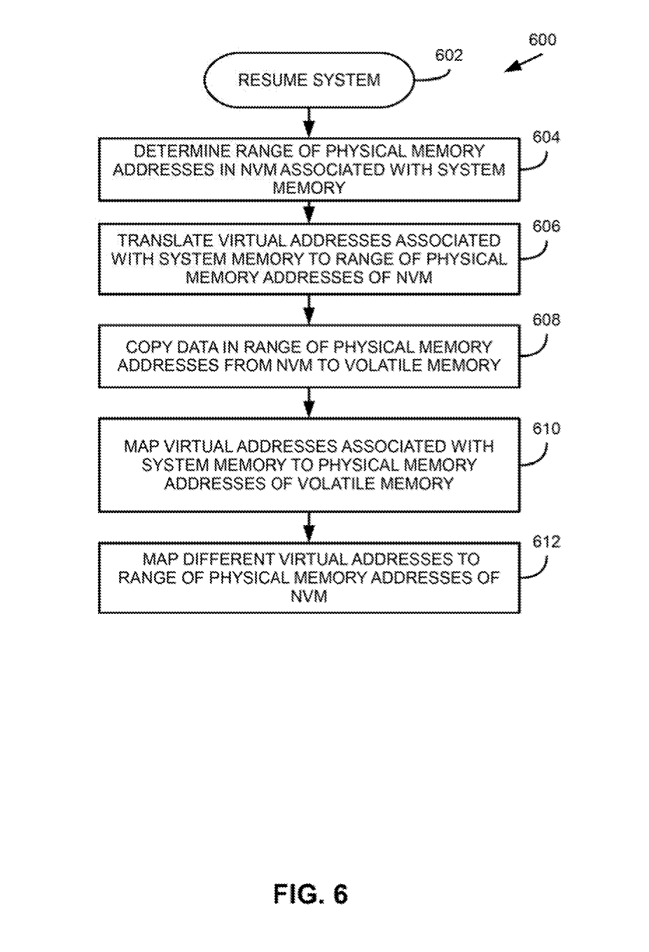

FIG. 6 provides a flowchart 600 that illustrates an example sequence of operations that may be performed by a system. As shown, responsive to resuming the system (block 602), the system determines a range of physical memory addresses of a non-volatile memory (NVM) of the system associated with a system memory (block 604). During processing of instructions, the system translates virtual addresses associated with the system memory to physical memory addresses of the range of physical memory addresses of the non-volatile memory (block 606). In addition, the system copies data stored in the range of physical memory addresses from the non-volatile memory to a volatile memory of the system (block 608), which may be referred to as migrating the system memory. As will be appreciated, copying the data stored in the range of physical memory addresses to the volatile memory may be performed concurrent with processing of instructions of various applications/processes executing in the system.

Responsive to copying the data in the range of physical memory addresses to the volatile memory, the system maps virtual addresses associated with the system memory to corresponding physical memory addresses of the volatile memory (block 610). As will be appreciated, after mapping the virtual addresses associated with the system memory to the physical memory addresses of the volatile memory, the system memory of the volatile memory may be used for processing instructions. In this example, after copying the data of the system memory to the volatile memory and mapping virtual addresses associated with the system memory to physical memory addresses of the volatile memory, the system may map different virtual addresses to the range of physical memory addresses of the non-volatile memory (block 612). Therefore, as will be appreciated, in examples similar to the example of FIG. 6, the portion of non-volatile memory used to store the system memory may be reused for other storage after the system memory is migrated to the volatile memory.

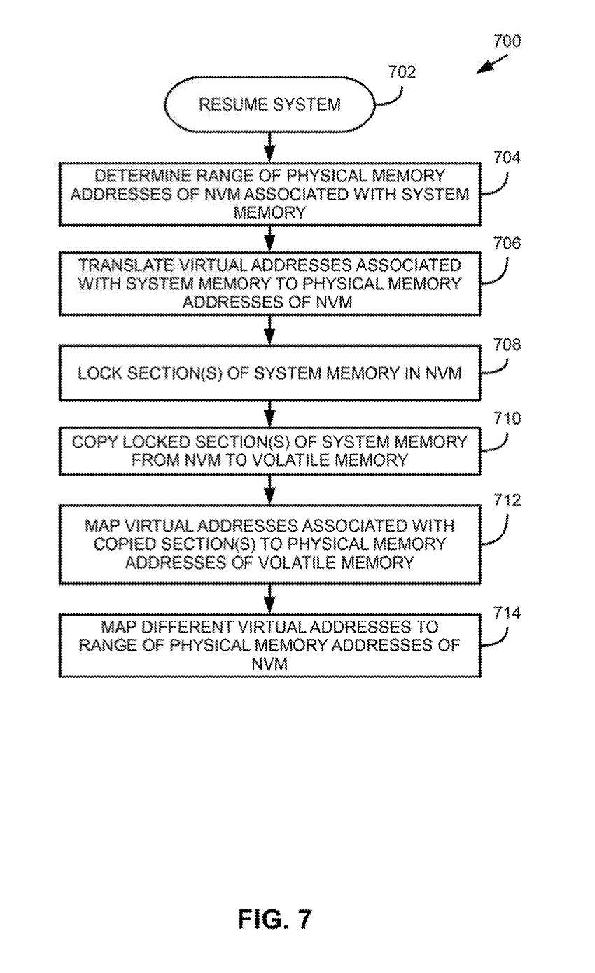

FIG. 7 provides a flowchart 700 that illustrates an example sequence of operations that may be performed by a system. In response to resuming the system to a prior state (block 702), the system may determine a range of physical memory addresses of a non-volatile memory associated with a system memory (block 704). After resuming the system, the system may translate virtual addresses associated with the system memory to physical memory addresses of the range of physical memory addresses of the non-volatile memory (block 706). In some examples, the system may migrate the system memory to a volatile memory in sections. As shown in this example, the system may lock at least one section of system memory in the non-volatile memory (block 708). In such examples, locking a section of system memory prevents writing of data to the locked section. After locking the at least one section, the system may copy the at least one locked section of system memory from the non-volatile memory to a volatile memory (block 710). Responsive to copying the locked sections of virtual memory to the volatile memory, the system may map virtual addresses associated with the copied at least one section of system memory to corresponding physical memory addresses of the volatile memory storing the copied at least one section (block 712). In some examples, the system may map different virtual addresses to the range of physical memory addresses of the non-volatile memory corresponding to the copied at least one section (block 714) such that the range of physical memory addresses of the non-volatile memory may be re-used.

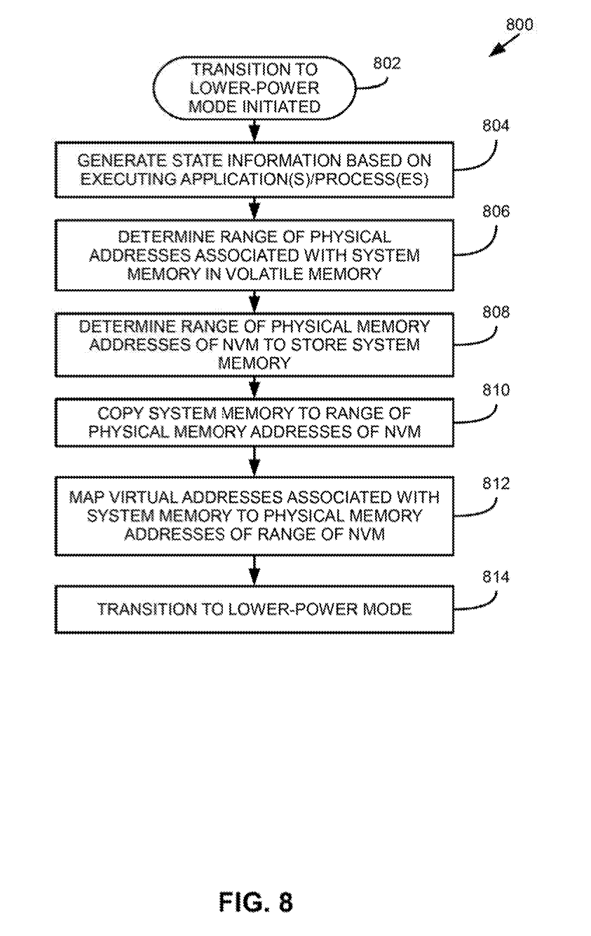

FIG. 8 provides a flowchart 800 that illustrates an example sequence of operations that may be performed by a system. In this example, a transition to a lower-power mode is initiated for the system (block 802). Prior to transitioning the system to the lower-power mode, the system generates state information for the system based on executing applications/processes (block 804). The state information may comprise instructions and data loaded for processing for one or more executing applications/processes. As will be appreciated, state information may be generated based on data stored in the system memory, the contents of cache memory, etc.

Examples of state information may comprise information associated with a current state of an operating system, information associated with a current state of executing applications/processes, information associated with a state of hardware components, and/or other such information that may be used to return the system to such current state upon resuming the system. State information may also comprise data used by an operating system, application, process, hardware component, etc. For example, if an application executing on the system corresponds to an electronic document being processed by the application, state information associated with the executing application may indicate current content of such document. In this example, upon resuming the system, based on the state information associated with the executing application, the system may restore the executing application with the content of such document for further processing.

The system determines a range of physical memory addresses associated with system memory that is stored in the volatile memory (block 806). The system determines a range of physical memory addresses of a non-volatile memory to store the system memory (block 808), and the system copies the data stored in the system memory of the volatile memory to the range of physical addresses of the non-volatile memory (block 810). The system maps virtual addresses associated with the system memory to the range of physical memory addresses of the non-volatile memory (block 812), and the system transitions to the lower-power mode (block 814).

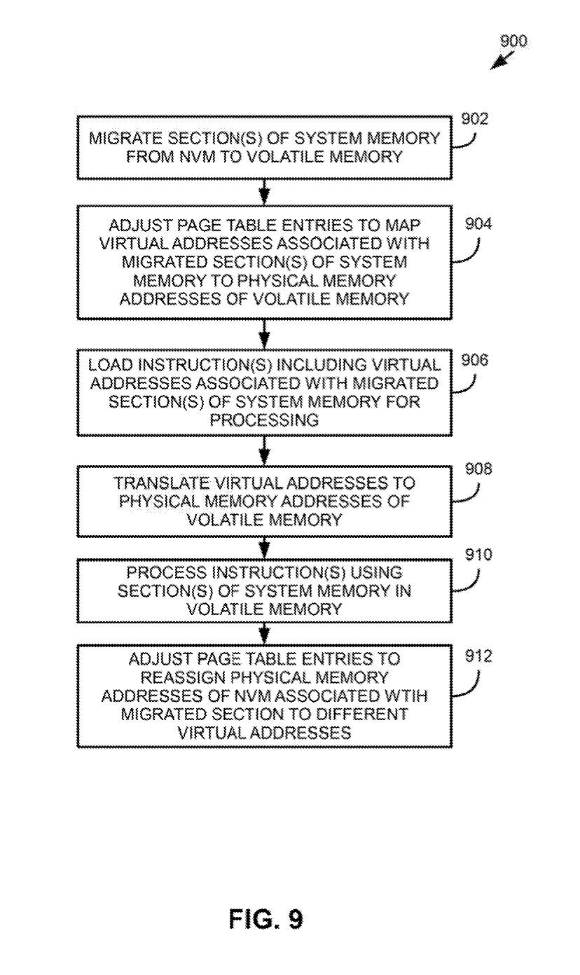

FIG. 9 provides a flowchart 900 that illustrates an example sequence of operations that may be performed by a system. In this example, the system migrates at least one section of system memory from a non-volatile memory to a volatile memory (block 902). As each section is migrated to the volatile memory, the system adjusts page table entries to map virtual addresses associated with migrated sections of the system memory to physical memory addresses of the volatile memory (block 904). As will be appreciated, in some examples, a translation look-aside buffer storing the page table entries is adjusted to thereby map virtual addresses associated with the system memory to physical memory addresses of the volatile memory. The system loads instructions that include virtual addresses associated with migrated sections of the system memory for processing (block 906), and the system translates the virtual addresses associated with the migrated sections to physical memory addresses of the volatile memory (block 908). As will be appreciated, the system may translate the virtual addresses based on the page table entries. After migration of the at least one section and the adjustment of the page table entries, the system processes instructions that include virtual addresses associated with migrated sections using the sections of system memory stored in the volatile memory (block 910). Furthermore, in some examples, the system may adjust page table entries to reassign physical memory addresses of the non-volatile memory that stored migrated sections to different virtual addresses (block 912).

Therefore, examples of systems, processes, methods, and/or computer program products implemented as executable instructions stored on a non-transitory machine-readable storage medium described herein may resume a system using system memory stored in a non-volatile memory. After resuming the system and during processing of instructions using the system memory in the non-volatile memory, examples may migrate the system memory to a volatile memory. After migrating the system memory to the volatile memory, the system may process instructions using the system memory stored in the volatile memory. Accordingly, examples may resume a system (e.g., boot-up, resume from hibernation, resume from suspension, return power to powered-down components, etc.) with system memory stored in the non-volatile memory to reduce boot time. In addition, examples may migrate the system memory to a volatile memory after resuming the system to reduce processing times, due to the faster read/write speeds that may be associated with the volatile memory.

In addition, while various examples are described herein, elements and/or combinations of elements may be combined and/or removed for various examples contemplated hereby. For example, the example operations provided herein in the flowcharts of FIGS. 5-9 may be performed sequentially, concurrently, or in a different order. Moreover, some example operations of the flowcharts may be added to other flowcharts, and/or some example operations may be removed from flowcharts. Furthermore, in some examples, various components of the example systems of FIGS. 1A-4 may be removed, and/or other components may be added. Similarly, in some examples various instructions of the example memories and/or machine-readable storage mediums of FIG. 2 may be removed, and/or other instructions may be added (such as instructions corresponding to the example operations of FIGS. 5-9).

The preceding description has been presented to illustrate and describe examples of the principles described. This description is not intended to be exhaustive or to limit examples to any precise form disclosed. Many modifications and variations are possible in light of this description.

1. A system comprising:
a non-volatile memory to store state information of at least one program executing in the system associated with a prior state of the system;
a volatile memory;
a processing resource to resume the system to the prior state using the state information stored in the non-volatile memory; and
a memory control engine to:
after resume of the system using the state information stored in the non-volatile memory, migrate a system memory stored in the non-volatile memory to the volatile memory.

2. The system of claim 1, wherein the memory control engine is further to:
prior to migration of the system memory from the non-volatile memory to the volatile memory, translate a first virtual memory address associated with the system memory received from the processing resource to a physical memory address of the non-volatile memory; and
after migration of the system memory from the non-volatile memory to the volatile memory, translate a second virtual memory address associated with the system memory received from the processing resource to a physical memory address of the volatile memory.

3. The system of claim 1, wherein the memory control engine is further to:
after migration of the system memory from the non-volatile memory to the volatile memory, adjust a translation look-aside buffer to map virtual addresses associated with the system memory to physical memory addresses of the volatile memory.

4. The system of claim 1, wherein the memory control engine is further to:
prior to transitioning the system to a lower-power mode:
copy the system memory stored in the volatile memory to the non-volatile memory;
store the state information of the at least one program executing in the system in the non-volatile memory; and
adjust a translation look-aside buffer to map virtual addresses associated with system memory to physical memory locations of the non-volatile memory.

5. The system of claim 1, further comprising:
a memory module that comprises the volatile memory and the non-volatile memory; and
a single memory controller connected to the memory module over a single channel.

6. The system of claim 1, further comprising:
a first memory module comprising the non-volatile memory;
a second memory module comprising the volatile memory; and
a memory controller connected to the first memory module over a first channel and connected to the second memory module over a second channel.

7. The system of claim 1, further comprising:
a first memory module comprising the non-volatile memory;
a second memory module comprising the volatile memory;
a first memory controller connected to the first memory module; and
a second memory controller connected to the second memory module.

8. A method comprising:
resuming a system to a prior state, with at least one processing resource of the system, based at least in part on state information stored in a non-volatile memory, the state information being associated with the prior state of the system;
executing a first instruction using a system memory stored in the non-volatile memory;
migrating the system memory to a volatile memory of the system; and
after migrating the system memory to the volatile memory of the system, executing a second instruction using the system memory stored in the volatile memory of the system.

9. The method of claim 8, wherein the non-volatile memory includes a range of physical memory addresses dedicated to storage of the system memory for the system, and the method further comprises:
in response to migrating the system memory to the volatile memory, reassigning at least one physical memory address of range of physical memory addresses dedicated to storage of the system memory in the non-volatile memory to a different virtual address.

10. The method of claim 8,
wherein executing the first instruction using the system memory stored in the non-volatile memory comprises translating a respective virtual address included in the first instruction and associated with the system memory to a respective physical memory address of the non-volatile memory, and
wherein executing the second instruction using the system memory stored in the volatile memory of the system comprises translating the respective virtual address included in the second instruction and associated with the system memory to a respective physical memory address of the volatile memory.

11. The method of claim 8, further comprising:
prior to transitioning the system to a lower-power mode:
generating the state information based at least in part on at least one application executing on the system;
copying the system memory from the volatile memory of the system to the non-volatile memory.

12. The method of claim 11, further comprising:
prior to copying the system memory from the volatile memory to the non-volatile memory, determining a range of physical memory addresses of the non-volatile memory in which to store the system memory; and
after copying the system memory to the non-volatile memory, adjusting page table entries to map virtual addresses associated with the system memory to corresponding physical memory addresses of the range of the non-volatile memory.

13. The method of claim 8, further comprising:
during migration of the system memory to the volatile memory:
executing a third instruction using at least one virtual address associated with a section of the system memory migrated to the volatile memory.

14. A non-transitory machine-readable storage medium comprising instructions executable by a processing resource of a system to cause the system to:
prior to transitioning the system to a lower-power mode, copy a system memory that is stored in a volatile memory of the system to a non-volatile memory of the system, the non-volatile memory including state information associated with a prior state of the system;
resume the system to the prior state based on the state information stored in the non-volatile memory;
after resuming the system to the prior state, translate virtual addresses associated with the system memory to physical memory addresses of the non-volatile memory associated with the system memory stored therein;
migrate the system memory to the volatile memory of the system; and
in response to migrating the system memory to the volatile memory of the system, translate virtual addresses associated with the system memory to physical memory addresses of the volatile memory associated with the system memory stored therein.

15. The non-transitory machine-readable storage medium of claim 14, wherein the system memory stored in the non-volatile memory comprises sections, and the system memory is migrated to the volatile memory of the system in sections, and the non-transitory machine readable storage medium further comprises instructions executable by the processing resource to cause the system to:
after migration of a respective section of the system memory, adjust a translation look-aside buffer to map a respective virtual address corresponding to the respective section of the system memory to a physical memory address of the volatile memory storing the respective section.
